(19) United States
(12) Patent Application Publication
(10) Pub. No.: US 2025/0381879 A1
(43) Pub. Date: Dec. 18, 2025

(54) ELECTRIC VEHICLE SUPPLY EQUIPMENT (EVSE) MANAGEMENT SYSTEM AND METHOD TO PROVIDE SECURED COMMUNICATION TO MULTIPLE EVSE

(71) Applicants: LITE-ON TECHNOLOGY CORPORATION, TAIPEI CITY (TW); LITE-ON SINGAPORE PTE. LTD., Singapore (SG)

(72) Inventors: Ken Weng KOW, Singapore (SG); Siong Hin GAN, Singapore (SG); Jen Ruey NG, Singapore (SG); Feng-Rong LIU, Taipei City (TW); Jung-Chih WEI, Taipei City (TW); Cheng-Ming CHIEN, Taipei City (TW)

(21) Appl. No.: 19/177,868

(22) Filed: Apr. 14, 2025

Related U.S. Application Data
(60) Provisional application No. 63/661,238, filed on Jun. 18, 2024.
(60) Provisional application No. 63/717,956, filed on Nov. 8, 2024.

(51) Int. Cl. B60L 53/68; B60L 53/67; H04L 9/32; H04L 67/12

(52) U.S. Cl. CPC B60L 53/68; B60L 53/67; H04L 9/3273; H04L 67/12

(57) ABSTRACT

A charger management system includes an edge controller and a cloud server. The edge controller establishes a non-encrypted connection with a first type charger according a first security profile, and converts a first charging message, formatted according to a first communication protocol and transmitted from the first type charger, into a second charging message formatted according to a second communication protocol. The cloud server establishes a first encrypted connection with the edge charger if the edge controller passes a first mutual authentication test according to a second security profile higher than the first security profile, and performs a charging station management service on the first type charger in response to the second charging message transmitted through the first encrypted connection.

### CROSS REFERENCE TO RELATED APPLICATIONS

This Application claims the benefit of U.S. Provisional Application No. 63/661,238, filed on Jun. 18, 2024, and U.S. Provisional Application No. 63/717,956, filed on Nov. 8, 2024, the entirety of which are incorporated by reference herein.

### BACKGROUND OF THE INVENTION

### Field of the Invention

The present invention relates to a secured communication system, and, in particular, it relates to an electric vehicle supply equipment (EVSE) management system and method to provide secured communication to multiple EVSE.

### Description of the Related Art

The Open Charge Point Protocol (OCPP) is a widely adopted protocol for communication between electric vehicle supply equipment (EVSE) and a central management system, known as the Charging Station Management System (CSMS). The CSMS provides a uniform way of exchanging information, such as status, meter values, and transaction-related data.

The OCPP has several security profiles, numbered 0, 1, 2, and 3. Security profiles 0 and 1 transmit messages in plain text, which poses a significant security risk as the data can be intercepted and read by unauthorized parties. This is particularly concerning given the sensitive nature of some of the data being transmitted, such as transaction details and user identification.

### BRIEF SUMMARY OF THE INVENTION

An embodiment of the present invention provides a charger management system. The charger management system includes an edge controller and a cloud server. The edge controller establishes a non-encrypted connection with a first type charger according a first security profile, and converts a first charging message, formatted according to a first communication protocol and transmitted from the first type charger, into a second charging message formatted according to a second communication protocol. The cloud server establishes a first encrypted connection with the edge controller if the edge controller passes a first mutual authentication test according to a second security profile higher than the first security profile, and performs a charging station management service on the first type charger in response to the second charging message transmitted through the first encrypted connection.

According to the charger management system described above, the edge controller further includes a first module and a second module. The first module performs a first identification test to validate a first identification of the first type charger. establishes the non-encrypted connection with the first type charger if the first type charger passes the first identification test. The first type charger receives the first charging message from the first type charger through the non-encrypted connection. The second module has a first topic for sending and receiving messages through the first encrypted connection. The second module converts the first charging message into the second charging message. The second module publishes the second charging message at the first topic.

According to the charger management system described above, the cloud server further includes a first network endpoint and a second network endpoint. The first network endpoint has a second topic for sending and receiving messages. The first network endpoint performs the first mutual authentication test to validate the edge controller. The first network endpoint establishes the first encrypted connection with the edge controller using a mTLS channel if the edge controller passes the first mutual authentication test. The first network endpoint subscribes the first topic to receive the second charging message through the first encrypted connection and publish the second charging message at the second topic. The second network endpoint subscribes the second topic to receive the second charging message, and performs the charging station management service on the first type charger based on the second charging message.

According to the charger management system described above, the first mutual authentication test includes the following steps. The cloud server sends a server certificate stored in the cloud server to the edge controller. The edge controller verifies the server certificate. The edge controller sends an edge certificate stored in the edge controller to the cloud server. The cloud server verifies the edge certificate.

According to the charger management system above, the edge controller and the cloud server further exchanges a first cryptographic key and encrypts the first encrypted connection based on the first cryptographic key if the edge controller passes the first mutual authentication test.

According to the charger management system described above, the edge controller stores a first identification set. The edge controller performs the first identification test by verifying whether a first identification of the first type charger pertains to the first identification set. The edge controller establishes the non-encrypted connection only if the first identification has been verified as authorized.

According to the charger management system described above, the first identification includes a non-encrypted password according to the first security profile. The edge controller further detects a first-time connection request from the first type charger. The edge controller stores a second identification in the first type charger to replace the first identification. The edge controller saves the second identification in the first identification set. If a subsequent connection request is made by the first type charger, the edge controller performs the first identification test by validating the second identification of the first type charger.

According to the charger management system described above, the cloud server further establishes a second encrypted connection with a second type charger if the second type charger passes a second identification test according to the second security profile. The cloud server receives a third charging message formatted in the first communication protocol and transmitted from the second type charger. The cloud server performs the charging station management service on the second type charger in response to the third charging message.

According to the charger management system described above, the second identification test is a second mutual authentication test, which is performed by the following steps. The cloud server sends the server certificate stored in the cloud server to the second type charger. The second type charger verifies the server certificate. The second type charger sends a charger certificate stored in the second type charger to the cloud server. The cloud server verifies the charger certificate.

According to the charger management system described above, the second type charger and the cloud server further exchanges a second cryptographic key and encrypt the second encrypted connection based on the second cryptographic key if the second type charger passes the second mutual authentication test.

According to the charger management system described above, the cloud server further stores a second identification set. The cloud server performs the second identification test by verifying whether a third identification of the second type charger belongs to the second identification set. The could server establishes the second encrypted connection only if the third identification has been verified as authorized.

According to the charger management system described above, the third identification includes an encrypted password according to the second security profile. The edge controller further detects a first-time connection request from the second type charger. The edge controller stores a fourth identification in the first type charger to replace the third identification. The edge controller saves the fourth identification in the second identification set. If a subsequent connection request is made by the second type charger, the edge controller performs the second identification test by validating the fourth identification of the second type charger.

According to the charger management system described above, the cloud server further includes a service network. The service network converts the third charging message to a fourth charging message according to the second communication protocol. The service network collects the second charging message and the fourth charging message. The service network performs the charging station management service on the first type charger and the second type charger in response to the second charging message and the fourth charging message respectively.

According to the charger management system described above, the first communication protocol is based on Open Charge Point Protocol (OCPP), the first type charger supports a security profile 0 or a security profile 1 of OCPP. The second communication protocol is based on Message Queuing Telemetry (MQTT).

According to the charger management system described above, the charging station management service includes handling a Boot Notification, a Remote Start Transaction, an EV driver service, a mobile application service, a payment service, an invoice service, a device service, or a transaction service based on the second charging message.

According to the charger management system described above, the cloud server further detects a first disconnection event associated with the first encrypted connection. If the first disconnection event exceeds a predefined time, the cloud server terminates the first encrypted connection until the edge controller passes the first mutual authentication test again.

According to the charger management system described above, the edge controller further includes a third module. The third module detects a second disconnection event indicating that the edge controller is not being connected to the Internet. The third module performs a local CSMS service on the first type charger in response to the first charging message transmitted through the non-encrypted connection. The local CSMS service includes handling a Boot Notification or a Remote Start Transaction.

### BRIEF DESCRIPTION OF THE DRAWINGS

The present invention can be more fully understood by reading the subsequent detailed description and examples with references made to the accompanying drawings, wherein:

FIG. 1 shows a schematic diagram of a charger management system 100 in accordance with some embodiments of the present invention;

FIG. 2 shows a flow chart of a first mutual authentication performed by the edge controller 102 and the cloud server 104 in FIG. 1 in accordance with some embodiments of the present invention;

FIG. 3 shows a schematic diagram of a charger management system 300 in accordance with some embodiments of the present invention;

FIG. 4 shows a detail schematic diagram of an edge controller 302 in FIG. 3 in accordance with some embodiments of the present invention;

FIG. 5 shows a flow chart of registering charger done by an operator 500, a device service 408, a CSMS service 314, and OCCP services 400 and 310 in accordance with some embodiments of the present invention; and

FIG. 6 shows a flow chart of EVSE connection done by the charger 306 and the charger 308, the OCCP services 300 and 310, and the CSMS service 314 in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” or “include” used in the present invention are used to indicate the existence of specific technical features, values, method steps, operations, units or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, or materials used in specific embodiments. However, the drawings should not be construed as defining or limiting the scope or properties encompassed by these embodiments. For example, for clarity, the relative size, thickness, and position of each layer, each area, or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, and “third” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

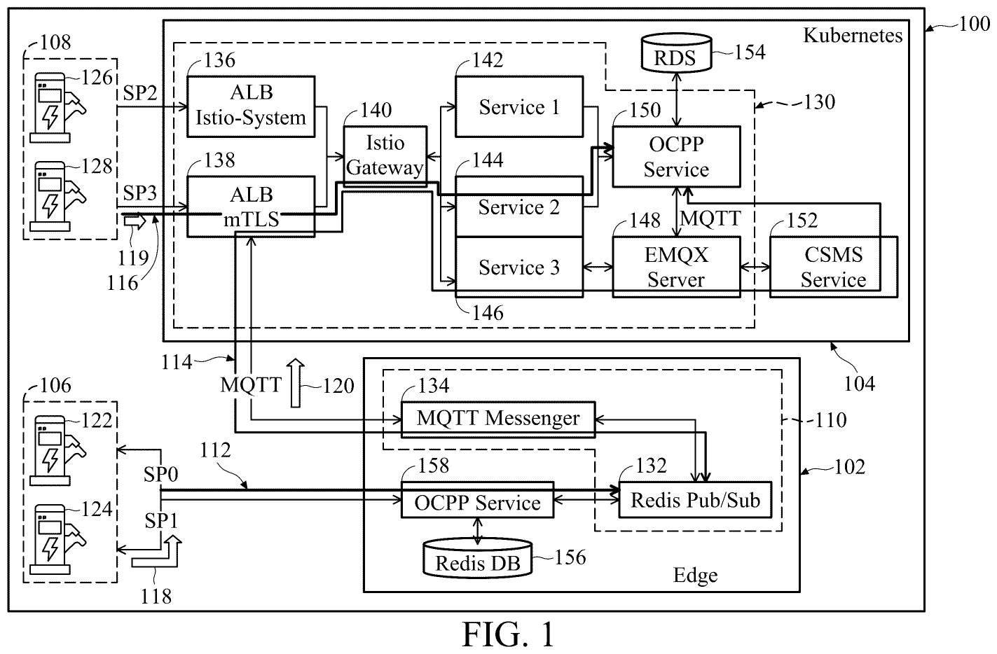

FIG. 1 shows a schematic diagram of a charger management system 100 in accordance with some embodiments of the present invention. As shown in FIG. 1, the charger management system 100 includes an edge controller 102 and a cloud server 104. The edge controller 102 establishes a non-encrypted connection 112 with a first type charger 106 according a first security profile including security profiles 0 and 1 (SP0 and SP1). The first type charger 106 includes a charger 122 and a charger 124. The non-encrypted connection 112 is a communication between the first type charger 106 and a Redis publisher and subscriber 132 through an OCPP service module 158. The charger 122 supports security profile 0 (SP0) for open charge point protocol (OCPP). The charger 124 supports security profile 1 (SP1) for OCPP. The edge controller 102 converts a first charging message 118, formatted according to a first communication protocol and transmitted from the first type charger 106, into a second charging message 120 formatted according to a second communication protocol. In some embodiments, the first communication protocol is based on OCPP. The second communication protocol is based on MQTT Message Queuing Telemetry (MQTT).

The cloud server 104 establishes a first encrypted connection 114 with the edge controller 102 if the edge controller 102 passes a first mutual authentication test according to a second security profile including security profiles 2 and 3 (SP2 and SP3) higher than the first security profile. The cloud server 104 performs a charging station management service (CSMS Service) on the first type charger 106 in response to the second charging message 120 transmitted through the first encrypted connection 114. In some embodiments, the first mutual authentication test is performed by an Application Load Balancer (ALB) Mutual TLS (mTLS) 138 included in the could server 104. The first encrypted connection 114 is a communication between the Redis publisher and subscriber 132 and an OCPP service module 150 through a Message Queuing Telemetry (MQTT) messenger 134, the ALB mTLS 138, a service three module 146, an EMQX server 148, and a Charging Station Management Service (CSMS) service module 152.

In some embodiments, the first mutual authentication test includes the following steps. First, the cloud server 104 sends a server certificate stored in the cloud server 104 to the edge controller 102. The server certificate may be stored in a Relational Database Service (RDS) 154 included in the cloud server 104. Then, the edge controller 102 verifies the server certificate. The edge controller 102 sends an edge certificate stored in the edge controller 102 to the cloud server 104. In some embodiments, the edge certificate is stored in a Redis Database (DB) 156 included in the edge controller 102. The cloud server 104 verifies the edge certificate.

In some embodiments, the edge controller 102 and the cloud server 104 exchange a first cryptographic key. The edge controller 102 and the cloud server 104 encrypt the first encrypted connection 114 based on the first cryptographic key if the edge controller 102 passes the first mutual authentication test.

In some embodiments, the edge controller 102 further performs an OCPP service to generate the OCPP service module 158. The OCPP service module 158 performs a first identification test to validate a first identification of the first type charger 106. The first identification test includes ID for SP0 or ID/password for SP1. The OCPP service module 158 establishes the non-encrypted connection 112 with the first type charger 106 if the first type charger 106 passes the first identification test. The OCPP service module 158 receives the first charging message 118 from the first type charger 106 through the non-encrypted connection 112.

The edge controller 102 further includes a second module 110. The second module 110 includes the Message Queuing Telemetry (MQTT) messenger 134 and the Redis publisher and subscriber 132. The second module 110 has a first topic for sending and receiving messages through the first encrypted connection 112. The second module 110 converts the first charging message 118 into the second charging message 120. The second module 110 publishes the second charging message 120 at the first topic. In some embodiments, MQTT uses a topic to publish and subscribe messages. That is, the topic refers to a specific channel or subject used for sending and receiving messages, such as in a publish-subscribe messaging pattern, implemented using protocols like MQTT (Message Queuing Telemetry Transport). Therefore, multiple chargers (for example, the chargers 122 and 124) in the first type charger 106 can be supported under limited bandwidth.

In some embodiments, the edge controller 102 further stores a first identification set. That is, operators need to register the EVSE (Charger Point ID) to the charger management system before the EVSE can establish a connection to the charger management system. The edge controller 102 performs the first identification test by verifying whether a first identification of the first type charger pertains to the first identification set. The edge controller 102 establishes the non-encrypted connection only if the first identification has been verified as authorized.

In some embodiments, the first identification includes a non-encrypted password according to the first security profile (SP0 and SP1). The edge controller 102 further detects a first-time connection request from the first type charger 106. The edge controller 102 stores a second identification in the first type charger to replace the first identification. The edge controller 102 saves the second identification in the first identification set. if a subsequent connection request is made by the first type charger 106, the edge controller 102 performs the first identification test by validating the second identification of the first type charger 106.

In some embodiments, the cloud server 104 further includes a first network endpoint 130. The first network endpoint 130 includes an ALB Istio-system 136, the ALB mTLS 138, an Istio gateway 140, a service one module 142, a service two module 144, a service three module 146, an EMQX server 148, and an OCPP service module 150. The first network endpoint 130 has a second topic for sending and receiving messages. The first network endpoint 130 performs the first mutual authentication test to validate the edge controller 102. The first network endpoint 130 establishes the first encrypted connection 114 with the edge charger 102 using a mTLS channel if the edge controller 102 passes the first mutual authentication test. The first network endpoint 130 subscribes the first topic to receive the second charging message 120 through the first encrypted connection 114 and publishes the second charging message 120 at the second topic.

The cloud server 104 further includes a CSMS service module 152. The CSMS service module 152 subscribes the second topic to receive the second charging message 120. The CSMS service module 152 performs the charging station management service on the first type charger 106 based on the second charging message 120.

In some embodiments, the cloud server 104 further establish a second encrypted connection 116 with a second type charger 108 if the second type charger 108 passes a second identification test according to the second security profile (SP2/SP3). The second type charger 108 includes a charger 126 and a charger 128. The charger 126 supports security profile 2 (SP2) for OCPP. The charger 128 supports security profile 3 (SP3) for OCPP. The cloud server 104 receives a third charging message 119 formatted in the OCPP and transmitted from the second type charger 108. The cloud server 104 performs the charging station management service on the second type charger 108 in response to the third charging message 119.

In some embodiments, the second identification test is a second mutual authentication test, which is performed by the following steps. The cloud server 104 sends the server certificate stored in the cloud server 104 to the second type charger 108. The server certificate may be stored in the RDS 154 included in the cloud server 104. The second type charger 108 verifies the server certificate. The second type charger 108 sends a charger certificate stored in the second type charger 108 to the cloud server 104. The cloud server 104 verifies the charger certificate.

In some embodiments, the second type charger 108 and the cloud server 104 further exchange a second cryptographic key and encrypt the second encrypted connection based on the second cryptographic key if the second type charger 108 passes the second mutual authentication test.

In some embodiments, the cloud server 104 further stores a second identification set. The cloud server 104 performs the second identification test by verifying whether a third identification of the second type charger 108 belongs to the second identification set. The cloud server 104 establishes the second encrypted connection only if the third identification has been verified as authorized.

In some embodiments, the third identification includes an encrypted password according to the second security profile. The edge controller 102 further detects a first-time connection request from the second type charger 108. The edge controller 102 stores a fourth identification in the first type charger 106 to replace the third identification. The edge controller 102 saves the fourth identification in the second identification set. If a subsequent connection request is made by the second type charger 108, the edge controller 102 performs the second identification test by validating the fourth identification of the second type charger 108.

In some embodiments, the cloud server 104 further includes a service network including the OCPP service module 150 and the CSMS service module 152. The OCPP service module 150 and the CSMS service module 152 convert the third charging message 119 to a fourth charging message according to MQTT. The OCPP service module 150 and the CSMS service module 152 collect the second charging message 120 and the fourth charging message. The OCPP service module 150 and the CSMS service module 152 perform the charging station management service on the first type charger 106 and the second type charger 108 in response to the second charging message 120 and the fourth charging message respectively.

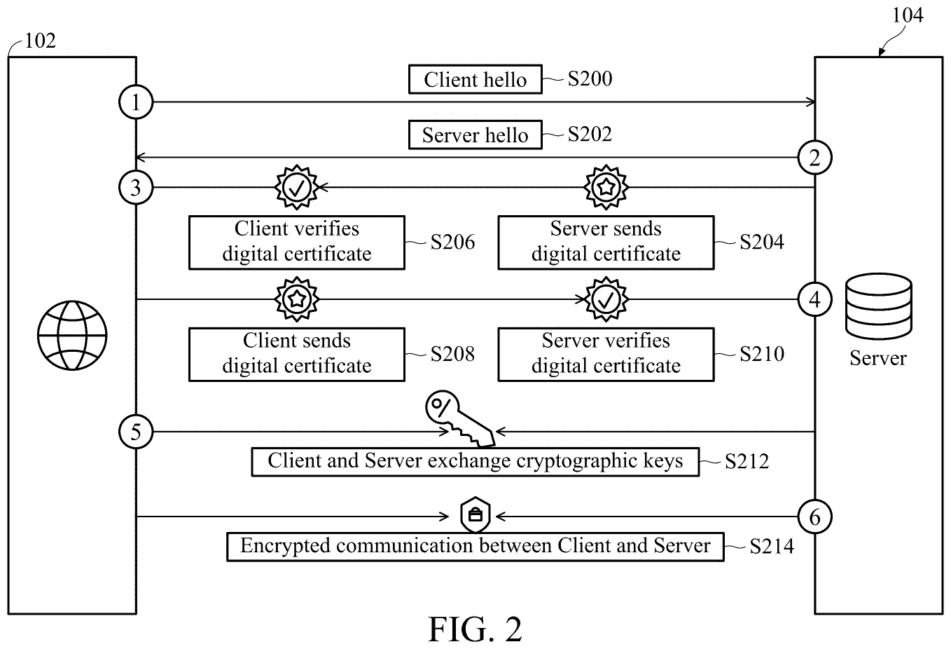

FIG. 2 shows a flow chart of a first mutual authentication performed by the edge controller 102 and the cloud server 104 in FIG. 1 in accordance with some embodiments of the present invention. In step S200, the edge controller 102 sends a hello message to the cloud server 104. The cloud server 104 also sends back the hello message to the edge controller 102 in step S202. Next, in step S204, the cloud server 104 sends a server certificate stored in the cloud server 104 to the edge controller 102 in step S204. In some embodiments, the server certificate may be stored in a Relational Database Service (RDS) 154 included in the cloud server 104. Then, the edge controller 102 verifies the server certificate in step S206. The server certificate is a digital certificate. The edge controller 102 sends an edge certificate stored in the edge controller 102 to the cloud server 104 in step S208. In some embodiments, the edge certificate is stored in a Redis Database (DB) 156 included in the edge controller 102. The cloud server 104 verifies the edge certificate in step S210. The edge certificate is a digital certificate. In step S212, the edge controller 102 and the cloud server 104 exchange a first cryptographic key. In step S214, the edge controller 102 and the cloud server 104 encrypt the first encrypted connection 114 based on the first cryptographic key if the edge controller 102 passes the first mutual authentication test.

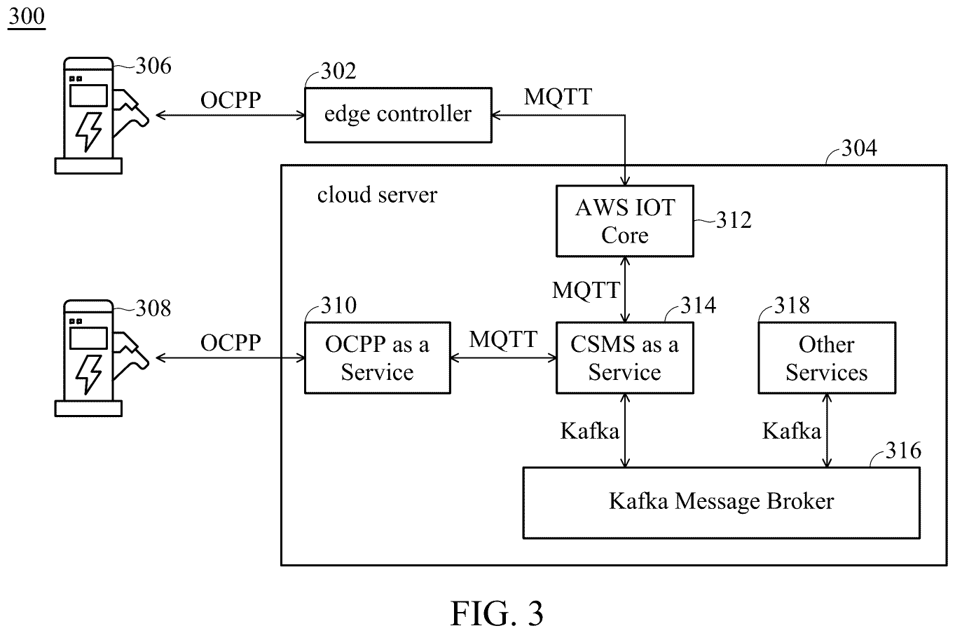

FIG. 3 shows a schematic diagram of a charger management system 300 in accordance with some embodiments of the present invention. As shown in FIG. 3, the charger management system 300 includes an edge controller 302, a cloud server 304, a charger point 306, and a charger point 308. The edge controller 102 is electrically connected to the charger 306. In some embodiments, the edge controller 102 is disposed near the charger 306, but the present invention is not limited thereto. The edge controller 102 validates the charger 306, and sends out encrypted data of the charger 306 when a mutual authentication test for the charger 306 is pass. The cloud server 104 is electrically connected to the charger 308 and the edge controller 102. The cloud server 104 validates the charger 308, receives the encrypted data of the charger 306, and performs a charging station management service (CSMS) service 314 on the charger 306 and the charger 308 when the charger 306 and the charger 308 have been registered. In some embodiments, the CSMS service 314 includes handling a Boot Notification, a Remote Start Transaction, an EV driver service, a mobile application service, a payment service, an invoice service, a device service, or a transaction service based on the second charging message 120 in FIG. 1.

In some embodiments, the charger 306 supports security profiles 0 and 1 for open charge point protocol (OCPP). The charger 308 supports security profiles 2 and 3 for OCPP. In some embodiments, the edge controller 102 performs an OCPP service to validate the charger 306 by determining whether the ID of the charger 306 matches registration information for security profiles 0 and 1, and whether the authorization key of the charger 306 matches the predetermined key for security profile 1. In some embodiments, the cloud server 304 performs an OCPP service 310 to validate the charger 308 by determining whether the ID of the charger 308 matches registration information for security profiles 2 and 3, whether the authorization key of the charger 308 matches the first predetermined key for security profile 2, and whether the certification key of the charger 308 matches the second predetermined key for security profile 3.

In detail, the edge controller 302 receives OCPP messages from the charger 306, and converts the OCPP messages to MQTT messages when the mutual authentication test for the charger 306 is pass. The MQTT messages are the encrypted data. After that, the cloud server 304 executes an AWS IOT core 312 to check whether the charger 306 has been registered. The cloud server 304 executes a Kafka message broker 316 to facilitate communication through Kafka messages between the CSMS service 314 and other services 318. In some embodiments, the other services 318 include an EV driver service, a mobile application service, a payment service, an invoice service, a device service, and a transaction service, but the present invention is not limited thereto. In some embodiments, the OCPP may include OCPP 1.6 and OCPP 2.01, but the present invention is not limited thereto.

For example, the EV driver service may record registration information of the driver. The registration information may include a driver name, a driver phone number, a driver credit card number for payment, and an invoice carrier. When the driver plugs the charger 306 in the charging hole of his EV, the cloud server 104 performs the CSMS service 314 on the charger 306 when the charger 306 has been registered. In some embodiments, the CSMS service 314 may include boot notification and remote start transaction, but the present invention is not limited thereto. In some embodiments, when the charger 308 performs a connection with the cloud server 304 for the first time using security profile 2, the cloud server 304 periodically updates the authorization key of the charger 308 for security profile 2.

In some embodiments, the charger 306 in FIG. 3 may correspond to the first type charger 106 in FIG. 1. The cloud server 304 detects a first disconnection event associated with the first encrypted connection 114 in FIG. 1. If the first disconnection event exceeds a predefined time, the cloud server 304 terminates the first encrypted connection 114 in FIG. 1 until the edge controller 302 passes the mutual authentication test again.

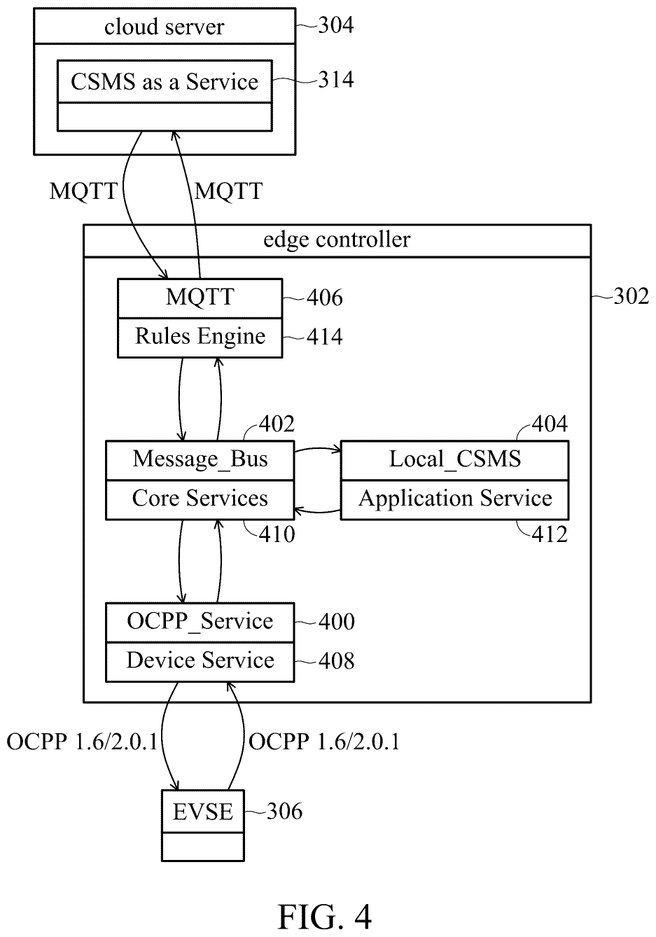

FIG. 4 shows a detail schematic diagram of the edge controller 302 in FIG. 3 in accordance with some embodiments of the present invention. in accordance with some embodiments of the present invention. As shown in FIG. 4, after receiving the OCPP messages from the charger 306, the edge controller 302 performs an OCPP service 300 to validate the charger 306 by determining whether the ID of the charger 306 matches registration information for security profiles 0 and 1, and whether the authorization key of the charger 306 matches the predetermined key for security profile 1. In some embodiments, the edge controller 302 performs a device service 408 to process the parameter setting of the charger 306. For example, the device service 408 may set the output voltage and the output current of the charger 306, but the present invention is not limited thereto. In some embodiments, the OCPP messages may be the messages for OCPP 1.6 and OCPP 2.01.

Next, the edge controller 302 performs a core service 410 to check whether the edge controller 302 is connected to the Internet. If the edge controller 302 is connected to the Internet, the edge controller 302 executes a rules engine 414 to convert the OCPP messages to MQTT messages 406. That is, the MQTT messages 406 are the encrypted data. However, the OCPP messages are not the encrypted data. The MQTT messages 406 are then sent to the cloud server 304 for the CSMS service 314. After that, the commands from the CSMS service 314 can be sent back to the charger 306 through the edge controller 302. If the edge controller 302 is not connected to the Internet, the edge controller 302 performs a local CSMS 404, which may include notification and remote start transaction. Accordingly, the edge controller 302 performs an application service 412 based on commands from the local CSMS 404, so that the charger 306 can still locally be used based on the local CSMS 404.

In some embodiments, the edge controller 302 performs the local CSMS 404 to detect a second disconnection event indicating that the edge controller 302 is not being connected to the Internet. the edge controller 302 performs the local CSMS 404 to perform a local CSMS service 404 on the charger 306 in response to the first charging message 118 in FIG. 1 transmitted through the non-encrypted connection 112 in FIG. 1. The local CSMS service 404 includes handling a Boot Notification or a Remote Start Transaction.

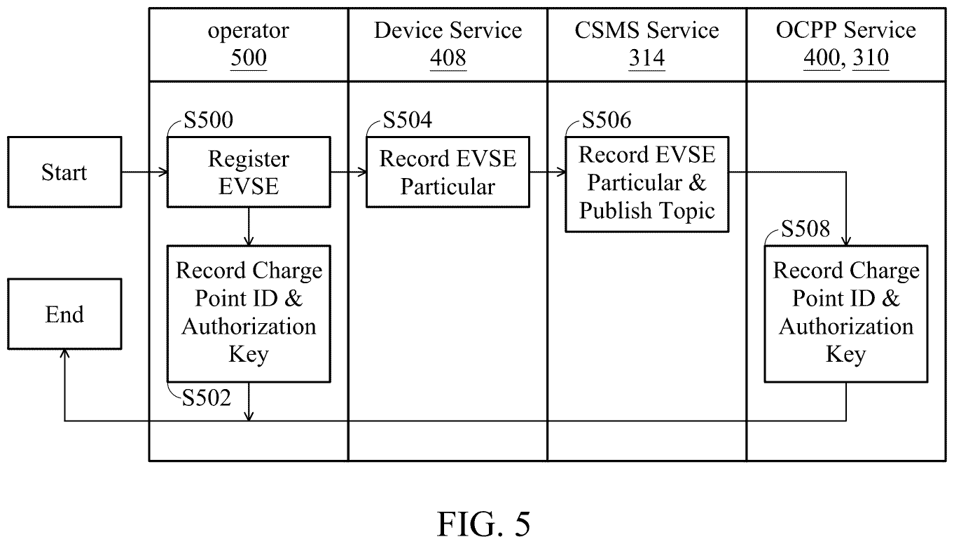

FIG. 5 shows a flow chart of registering charger done by an operator 500, a device service 408, a CSMS service 314, and OCCP services 400 and 310 in accordance with some embodiments of the present invention. As shown in FIG. 5, the operator 500 first register EVSE (step S500). For example, the operator 500 may first register the charger 306 and the charger 308 in FIG. 3. Then, the operator 500 may record charger ID and the authorization key of the charger 306 and the charger 308 (step S502). Next, the device service 408 records EVSE including the charger 306 and the charger 308 in particular (step S504). Then, the CSMS service 314 records EVSV including the charger 306 and the charger 308 in particular and publishes the topic through MQTT messages (step S506).

The OCPP services 400 and 310 record the charger ID and the authorization key of the charger 306 and the charger 308 (Step S508). Once the driver plugs the charger 306 in the charging hole of his EV, the OCPP service 400 performed by the edge controller 302 validates the charger 306 by determining whether the ID of the charger 306 matches the registration information for security profiles 0 and 1, and whether the authorization key of the charger 306 matches the predetermined key for security profile 1. Once the driver plugs the charger 308 in the charging hole of his EV, the OCPP service 310 performed by the cloud server 304 validates the charger 308 by determining whether the ID of the charger 308 matches registration information for the security profiles 2 and 3, whether the authorization key of the second EV charger matches a first predetermined key for the security profile 2, and whether the certification key of the charger 308 matches the second predetermined key for security profile 3.

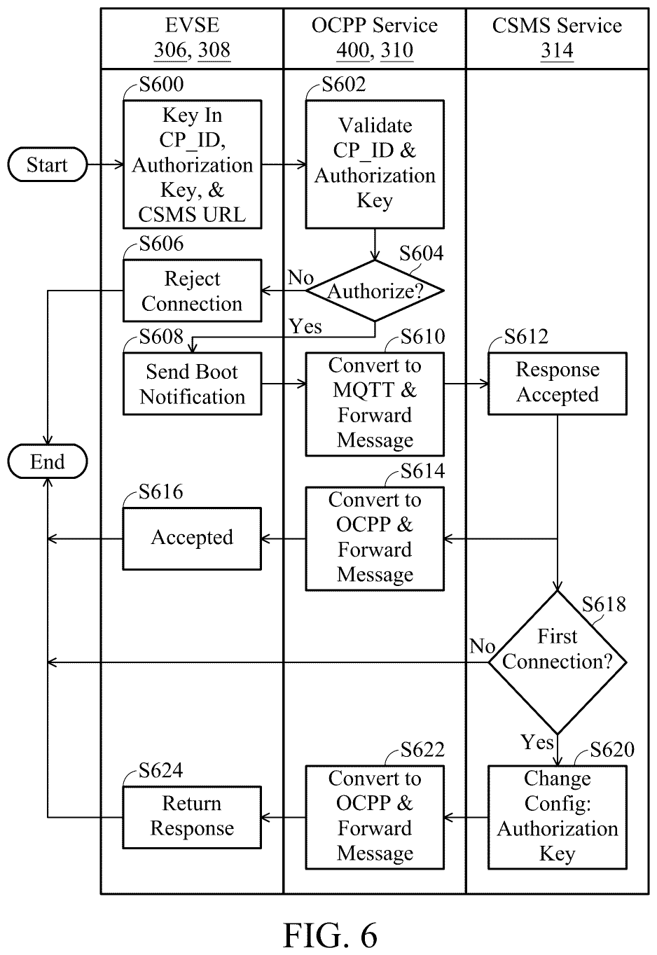

FIG. 6 shows a flow chart of EVSE connection done by the charger 306 and the charger 308, the OCCP services 300 and 310, and the CSMS service 314 in accordance with some embodiments of the present invention. The charger 306 and the charger 308 are marked by EVSE 306, 308. In step S600, the charger ID (CP_ID) and the authorization key of the charger 306 and the charger 308 are keyed in using the CSMS URL. After step S600 is done, the charger 306 and the charger 308 have been registered. In step S6602, when the driver plugs the charger 306 and the charger 308 in the charging hole of his EV, the OCPP service 400 validate the charger ID and the authorization key of the charger 306, and the OCPP service 310 validate the charger ID and the authorization key of the charger 308.

In step S604, the OCPP service 400 determines whether the charger 306 is authorized, and the OCPP service 310 determines whether the charger 308 is authorized. If the answer in step S604 is no, the OPCC services 400 and 310 respectively send a disable signal to the charger 306 and the charger 308 to reject connection or communication with the charger 306 and the charger 308 (step S606). In contrast, if the answer in step S604 is yes, the OPCC services 400 and 310 respectively send an enable signal to the charger 306 and the charger 308, so that the charger 306 and the charger 308 sends boot notification to the OCPP services 400 and 310 based on the enable signal (step S608).

Afterwards, the OCPP services 400 and 310 convert the OCPP messages to MQTT messages and forward the MQTT messages to the CSMS service 314 (step S610). In step S612, the CSMS service 314 receives the MQTT messages, and performs corresponding response according to the MQTT messages. The commands related to the corresponding response is sent to the OCPP services 400 and 310 using the MQTT messages. The OCPP services 400 and 310 convert the MQTT messages back to the OCPP messages, and forward the OCPP messages (step S614). The charger 306 and the charger 308 receive the OCPP messages and perform corresponding actions based on the OCPP messages (step S616).

In some embodiments, in step S618, the CSMS service 314 determines whether the charger 306 or the charger 308 has a first connection with the cloud server 304. If the CSMS service 314 determines that the charger 306 performs the connection with the cloud server 304 for the first time using security profile 1 or the charger 108 performs the connection with the cloud server 304 for the first time using security profile 2 (that is, the answer is yes in step S618). For example, the present invention takes the charger 308 as an example. The CSMS service 314 executes a change-config command to updates or changes the authorization key of the charger 308 (step S620). The command to update or change the authorization key of the charger 308 is sent to the OCPP service 310 (step S622) using the MQTT messages. The OCPP service 310 converts the MQTT messages back to the OCPP messages, and forwards the OCPP messages to the charger 308 (step S622). The charger 308 is configured by the OCPP messages from the CSMS service 314 to change its authorization key (step S624).

In the current market, there are still some EVSE that do not support the security profile 2 or 3. With the proposed solution, the messages from the field to the cloud can be encrypted. For EVSE connecting directly to the cloud, the authorization key will be updated. This prevents contractors who initiate the connection from acting as the installed EVSE and establishing a connection to the CSMS. The Top-Down mechanism (that is, the EVSE should first be registered by the operator) also ensures that unregistered EVSE are unable to connect to the CSMS. This filters out unnecessary connections to the CSMS, which in return saves resources on maintaining the connection.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. A charger management system, comprising:
an edge controller, configured to:
establish a non-encrypted connection with a first type charger according a first security profile; and
convert a first charging message, formatted according to a first communication protocol and transmitted from the first type charger, into a second charging message formatted according to a second communication protocol; and
a cloud server, configured to:
establish a first encrypted connection with the edge controller if the edge controller passes a first mutual authentication test according to a second security profile higher than the first security profile; and
perform a charging station management service on the first type charger in response to the second charging message transmitted through the first encrypted connection.

2. The charger management system as claimed in claim 1, wherein the edge controller comprises:
a first module, configured to:
perform a first identification test to validate a first identification of the first type charger;
establish the non-encrypted connection with the first type charger if the first type charger passes the first identification test; and
receive the first charging message from the first type charger through the non-encrypted connection;
a second module, having a first topic for sending and receiving messages through the first encrypted connection, configured to:
convert the first charging message into the second charging message; and
publish the second charging message at the first topic.

3. The charger management system as claimed in claim 2, wherein the cloud server comprises:
a first network endpoint, having a second topic for sending and receiving messages, configured to:
perform the first mutual authentication test to validate the edge controller;
establish the first encrypted connection with the edge controller using a mTLS channel if the edge controller passes the first mutual authentication test; and
subscribe the first topic to receive the second charging message through the first encrypted connection and publish the second charging message at the second topic;
a second network endpoint, configured to:
subscribe the second topic to receive the second charging message; and
perform the charging station management service on the first type based on the second charging message.

4. The charger management system as claimed in claim 2, wherein the mutual authentication test comprises:
the cloud server sending a server certificate stored in the cloud server to the edge controller;
the edge controller verifying the server certificate;
the endpoint controller sending an edge certificate stored in the edge controller to the cloud server; and
the cloud server verifying the edge certificate.

5. The charger management system as claimed in claim 1, wherein the edge controller and the cloud server are further configured to:
exchange a first cryptographic key; and
encrypt the first encrypted connection based on the first cryptographic key if the edge controller passes the first mutual authentication test.

6. The charger management system as claimed in claim 1, wherein the edge controller is further configured to:
store a first identification set;
perform the first identification test by verifying whether a first identification of the first type charger pertains to the first identification set; and
establish the non-encrypted connection only if the first identification has been verified as authorized.

7. The charger management system as claimed in claim 6, wherein the first identification comprises a non-encrypted password according to the first security profile, and the edge controller is further configured to:
detect a first-time connection request from the first type charger;
store a second identification in the first type charger to replace the first identification;
save the second identification in the first identification set; and
if a subsequent connection request is made by the first type charger, perform the first identification test by validating the second identification of the first type charger.

8. The charger management system as claimed in claim 1, wherein the cloud server is further configured to:
establish a second encrypted connection with a second type charger if the second type charger passes a second identification test according to the second security profile;
receive a third charging message formatted in the first communication protocol and transmitted from the second type charger; and
perform the charging station management service on the second type charger in response to the third charging message.

9. The charger management system as claimed in claim 8, wherein the second identification test is a second mutual authentication test, the second mutual authentication test comprises:
the cloud server sending the server certificate stored in the cloud server to the second type charger;
the second type charger verifying the server certificate;
the second type charger sending a charger certificate stored in the second type charger to the cloud server; and
the cloud server verifying the charger certificate.

10. The charger management system as claimed in claim 9, wherein the second type charger and the cloud server further configured to:
exchange a second cryptographic key; and
encrypt the second encrypted connection based on the second cryptographic key if the second type charger passes the second mutual authentication test.

11. The charger management system as claimed in claim 8, wherein the cloud server is further configured to:
store a second identification set;
perform the second identification test by verifying whether a third identification of the second type charger belongs to the second identification set; and
establish the second encrypted connection only if the third identification has been verified as authorized.

12. The charger management system as claimed in claim 11, wherein the third identification comprises an encrypted password according to the second security profile, and the edge controller is further configured to:
detect a first-time connection request from the second type charger;
store a fourth identification in the first type charger to replace the third identification;
save the fourth identification in the second identification set; and
if a subsequent connection request is made by the second type charger, perform the second identification test by validating the fourth identification of the second type charger.

13. The charger management system as claimed in claim 8, wherein the cloud server comprises a service network, and is configured to:
convert the third charging message to a fourth charging message according to the second communication protocol;
collect the second charging message and the fourth charging message;
perform the charging station management service on the first type charger and the second type charger in response to the second charging message and the fourth charging message respectively.

14. The charger management system as claimed in claim 1, wherein the first communication protocol is based on OCPP, the first type charger supports a security profile 0 or a security profile 1 of OCPP, and the second communication protocol is based on MQTT.

15. The charger management system as claimed in claim 1, wherein the charging station management service comprises handling a Boot Notification, a Remote Start Transaction, an EV driver service, a mobile application service, a payment service, an invoice service, a device service, or a transaction service based on the second charging message.

16. The charger management system as claimed in claim 1, wherein the cloud server is further configured to:
detect a first disconnection event associated with the first encrypted connection; and
if the first disconnection event exceeds a predefined time, terminate the first encrypted connection until the edge controller passes the first mutual authentication test again.

17. The charger management system as claimed in claim 2, wherein the edge controller further comprises:
a third module, configured to:
detect a second disconnection event indicating that the edge controller is not being connected to the Internet; and
perform a local CSMS service on the first type charger in response to the first charging message transmitted through the non-encrypted connection, wherein the local CSMS service comprises handling a Boot Notification or a Remote Start Transaction.
